(19) United States
(12) Patent Application Publication
(10) Pub. No.: US 2013/0031097 A1
(43) Pub. Date: Jan. 31, 2013

(54) SYSTEM AND METHOD FOR ASSIGNING SOURCE SENSITIVE SYNONYMS FOR SEARCH

(71) Applicants: Mark SUTTER, Farmington, CT (US); Simon Yelsky, Montvale, NJ (US); Brett Norton, Somerset, NJ (US)

(72) Inventors: Mark SUTTER, Farmington, CT (US); Simon Yelsky, Montvale, NJ (US); Brett Norton, Somerset, NJ (US)

(21) Appl. No.: 13/559,960

(22) Filed: Jul. 27, 2012

Related U.S. Application Data
(60) Provisional application No. 61/512,963, filed on Jul. 29, 2011.

(51) Int. Cl. G06F 17/30

(52) U.S. Cl. 707/737; 707/E17.009

(57) ABSTRACT

A system and method for the content-sensitive tagging of a document including creating a content-specific domain on a database, creating a document associated with the content-specific domain, analyzing the document to identify a term, the term being associated with a content-sensitive synonym set assigned to the content-specific domain, and associating the document with a plurality of terms contained within said content-sensitive synonym set based on the term identified in the document.

### CROSS-REFERENCE TO RELATED APPLICATION

This application claims the benefit of U.S. Provisional Patent Application No. 61/512,963, filed, Jul. 29, 2011, entitled “SYSTEM AND METHOD FOR ASSIGNING SOURCE SENSITIVE SYNONYMS FOR SEARCH” which is hereby incorporated by reference in its entirety herein.

### FIELD OF THE INVENTION

This invention relates to systems and methods that facilitate the automatic tagging of content with additional information to enhance the effectiveness of search retrieval of this content.

### BACKGROUND

Knowledge management and search (e.g. creating and searching for document) is a central part of the operation of modern enterprise. Optimization in any part of the creation of knowledge and the process of retrieving the knowledge is therefore of prime importance. One of the existing enhancements to ordinary search technology is that, at the time of search, additional concepts and synonyms are added to the search to capture the true intent of the searcher and to ensure that the proper content is retrieved regardless of how the question is being asked. This may be done in a variety of ways.

Existing search approaches are typically performed on the search side, at the time of the search, in a uniform way across all the content being searched at that time.

For example, internally at many enterprises employees/managers may assign internal names to products. An ERP solution may be used, for example, but instead of referring to the product name it is given a new proper name, such as ‘Jane’. A user may want a search on ‘Jane’ to also access content that refers to the ERP product name, and vice-versa.

The addition of concepts and synonyms to the search-side of a search is typically performed automatically by algorithms incorporated within a search engine. However, these algorithms typically only add synonyms based on the word searched (e.g., ‘Jane’) and may not include terms that are traditional synonyms but nevertheless mean the same thing (e.g., an ERP product name).

### SUMMARY

Embodiments of the present invention may provide a system and method for providing content-sensitive synonym sets and contexts for knowledge management and search. Tagging (e.g., associating or affiliating) knowledge at the content-generation source, according to embodiments of the present invention, in a way that is sensitive to which set of content is being generated may provide varied benefits.

Embodiments of the present invention may include a system and method for the content-sensitive tagging of a document including creating a content-specific domain on a database, creating a document associated with the content-specific domain, analyzing the document to identify a term, the term being associated with a content-sensitive synonym set assigned to, contained within, or associated with the content-specific domain, and associating (e.g., affiliating or tagging) the document with a plurality of terms contained within the content-sensitive synonym set based on the term identified in the document.

### BRIEF DESCRIPTION OF THE DRAWINGS

The principles and operation of the system, apparatus, and method according to embodiments of the present invention may be better understood with reference to the drawings, and the following description, it being understood that these drawings are given for illustrative purposes only and are not meant to be limiting.

FIG. 1 is a flow chart illustrating a method for the content-specific tagging of a document according to embodiments of the invention;

FIG. 2 is a block diagram of a knowledge management system according to embodiments of the invention;

FIG. 3 is a block diagram of a knowledge management system according to embodiments of the invention; and

FIG. 4 is a high level block diagram of an exemplary computing device according to embodiments of the present invention.

For simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate correspondence or analogous elements throughout the serial views.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as is apparent from the following discussions, it is appreciated that throughout the specification discussions utilizing terms such as “processing”, “computing”, “storing”, “determining”, or the like, refer to the actions and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. Such apparatuses may be specially constructed for the desired purposes, or may comprise controllers, computers or processors selectively activated or reconfigured by a computer program stored in the computers. Such computer programs may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus. It will be appreciated that a variety of programming languages may be used to implement the teachings of the invention as described herein.

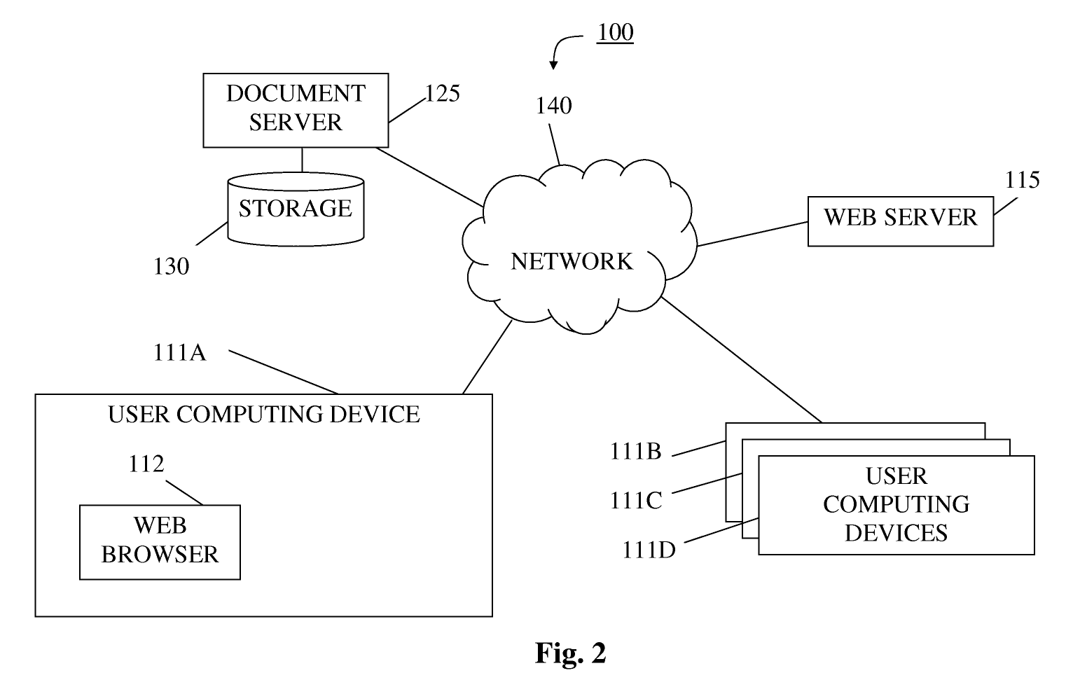

Unless specifically stated otherwise, as apparent from the following discussions, it is appreciated that an article, document, item, solution, result or search result, as it is referred to herein, may be a piece or item of content which may be stored in a repository or database, or is, or is intended to, be produced or yielded in a search, or is otherwise returned as, for example, a single link in a listing of search results. In certain embodiments the articles, documents, items, solutions, results or search results may be stored in, for example, storage 130 (FIG. 2). Unless specifically stated otherwise, the term knowledge, as used herein, may represent an article, document, solution, result, search result or otherwise content contained on the knowledge management system. For example, content, documents or other items searched may be text documents such as created using a word processor or other program, documents stored in .pdf format, databases (e.g., .xls documents), presentations (e.g., stored in .ppt format) or other documents. A search typically involves a user entering search terms and possibly modifiers (e.g., ‘patent’ and ‘inventor’) into a search program, and the search program returning a list, typically ordered according to some measure of relevance, of documents in a certain domain or database, relevant to the search terms.

A term, as it is referred to herein, may be a word, phrase or other set of characters together that represent a particular idea that could act like a word for searching purposes. For example, the term “HRLG3457” could be a term representing a particular piece of equipment which might be searched for.

A synonym, as it is referred to herein, may be two or more words, terms or phrases that are taken to have the same or nearly the same meaning. As used herein, synonym may additionally mean a word or phrase that by association is held to embody something such as, for example, a concept or quality. In certain embodiments, it may be desirable for a searcher (e.g., a user) to obtain search results, or content, which is responsive to a synonym of a term or phrase used in a search query. For example, a user may search for the term “Jane”, a product nickname, but also desire search results responsive to the ERP product name. In addition, a user may search for the term “monitor” but also desire search results responsive to “screen”, “touchscreen” and “LED screen”.

A synonym set, as it is referred to herein, may be a series (e.g., a plurality of) terms, words or phrases that embody a single concept or meaning, or a group of similar or nearly similar concepts or meanings. In certain embodiments, a synonym set may refer to a set of synonyms that appear in, for example, a thesaurus. In other embodiments, a synonym set may include terms or words which are not normally associated with each other. For example, a synonym set may include a cataloged product name (e.g., HRLG3457) as well as the product nickname (e.g., “Jane”). In some embodiments, a user or administrator of the knowledge management system may add terms or phrases to a particular synonym set as synonyms are learned.

In some embodiments, each synonym set may be content-specific or content-sensitive. As used herein, content-specific or content-sensitive, may indicate that each synonym set is limited to a certain knowledge base of content. For example, a synonym set may include a set (e.g., plurality or series) of terms that relate to the concept of the sport of baseball. In certain embodiments, there may be a single synonym set for each concept or each knowledge base of content. In other embodiments, there may be multiple synonym sets for each knowledge base of content. For example, if a knowledge base of content represents the concept of the sport of baseball, there may be a synonym set for each of the terms “bat”, “ball”, “base”, “glove”, “hit” and “run” associated with that knowledge base of content. As described in further detail below, a knowledge base of content or concept may be a domain.

A domain, as it is referred to herein, may be a subset of knowledge for which a consistent set of synonyms may be defined. In certain embodiments, a domain may contain knowledge relevant to only a single concept such as, for example, baseball, or it may contain knowledge relevant to multiple concepts. A knowledge management system, as described herein, may contain one domain of knowledge or it may contain a plurality of domains (e.g., two or more). In certain embodiments, each domain may be searched separately by a user.

In certain embodiments, a domain, as referred to herein, may be a partitioned database contained on or in, for example, storage 130 (FIG. 2). In certain embodiments, each domain may contain knowledge (e.g., documents, articles, solutions, etc.) relevant to a particular concept or context. For example, a knowledge management system may include a domain with knowledge relevant to the sport of baseball and a domain with knowledge relevant to mammals. A search for the term “bat” performed on each of these domains would access different knowledge and, therefore, the search results for each search would be very different.

A content-specific domain, as used herein, may be a domain specific to a particular subject, concept or context and may contain knowledge relevant or responsive to that concept or content.

In certain embodiments, each domain may be associated with or include a synonym set, or multiple synonym sets, specific to the content contained in the domain.

A knowledge management system of the present invention may include at least one content-specific domain associated with at least one content-specific synonym set.

A context, as it is referred to herein, may be a concept structure or other object used to group or cluster together content within a particular subject matter domain. For example, the term “baseball” and the term “animal” might be a constructed context used to tag or associate content such that it is known that an article and/or search session containing the term “bat” is really looking for the animal or the game playing instrument. Tagging may include adding terms (e.g., search terms) to metadata of a document which are not literally in the document, where a synonym of the terms is literally (or in some derivation form, such as a plural or tense) the document.

Tagging, as it is referred to herein, may be associating or affiliating an item of information with another item of information and may be used to help identify or find the tagged item. For example, in certain embodiments, a document or article may be tagged with a synonym set. By tagging the document with the synonym set, a user searching for the document may be able to find the document by searching for any term contained in the synonym set. That is, the document is associated or affiliated with the synonym set. A document may be tagged, or associated/affiliated with, multiple synonym sets.

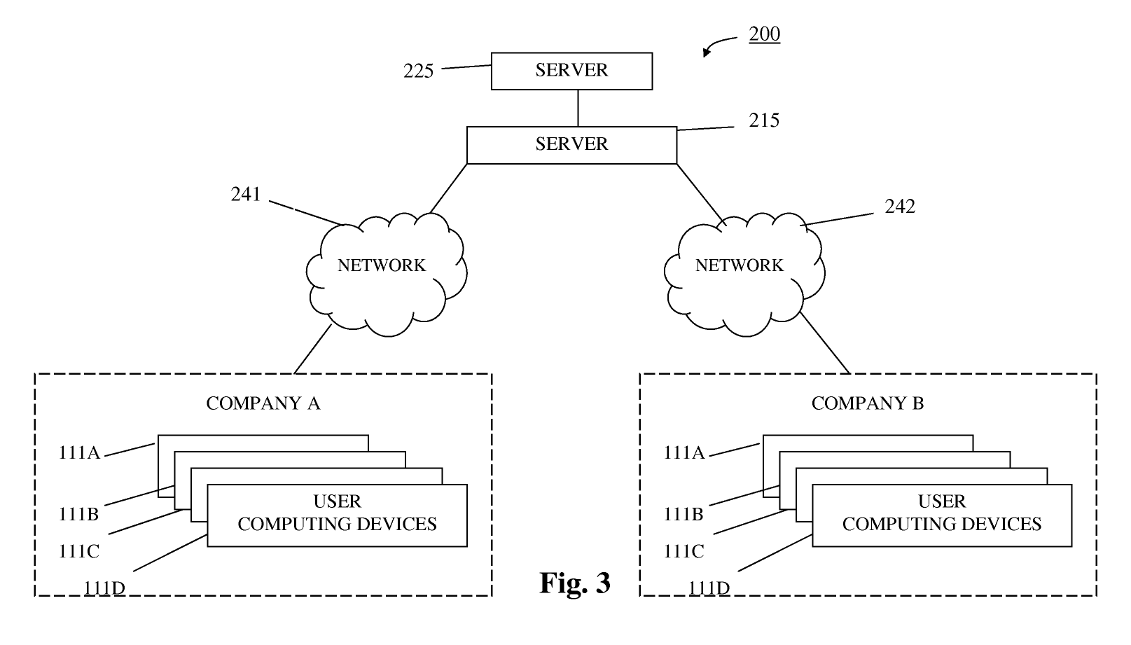

In certain embodiments, domains, documents or articles (e.g., knowledge), and synonym sets may be stored on a database (or one or more databases, such as a document database and a synonym database) or memory storage unit such as, for example, a storage 130 (FIG. 2), and may be accessed through, for example, document server 125 (FIG. 2) or one of servers 215 or 225 (FIG. 3) by user computing devices 111A-D via network 140 (FIG. 2) or networks 241 or 242 (FIG. 3). Different documents within the document database, or different sets of documents, may have different synonym sets used for term addition or tagging.

In some embodiments of the present invention, synonyms or synonym sets may be created on the content generation side of authoring and searching. The content may be permanently or semi-permanently tagged with a synonym set rather than a search engine generating synonyms based on the term searched. For example, synonyms may be created on the basis of what classification, group or domain that a particular piece of content is being authored from or associate with. Content-sensitive synonyms or synonym sets may be created based on what content or knowledge is contained in a content-sensitive domain.

In some embodiments, a user or administrator of the knowledge management system may create a content-specific domain. A user or administrator of the knowledge management system may create knowledge (e.g., documents or articles) to associate with, or store on, a content-specific domain. In certain embodiments, a user or administrator of the knowledge management system may create a content-specific (e.g., content-sensitive) synonym set, or multiple synonym sets, to associate with, or store on, a content-specific domain. In certain embodiments, the knowledge management system may analyze, either automatically or by being prompted, knowledge associated with a content-specific domain and tag (e.g., associate or affiliate) that knowledge with a content-sensitive synonym set associated with the content-specific domain.

Some embodiments of the system and method as discussed herein may be used, for example, with a search system on a closed, typically private or enterprise database (e.g., a specific medical journal's database of articles, a pharmaceutical company's database of products, or a university's database of technology related issues) such as shown in, for example, FIG. 2. In other embodiments a public search engine may be used for searching publicly available documents, e.g. available via (“on”) the Internet. A public search engine typically operates in a somewhat competitive environment as opposed to a private system. A public system may have multiple pieces of content attempting to answer questions, the documents produced by different authors who all want to get the “hit” or the document found by a search. Thus it is possible for an embodiment to suggest adding particular words more often into content so that the content will beat other existing content for the most common searches.

Certain embodiments may include or operate with a basic knowledge authoring system (e.g., executed by server 125 (FIG. 2) or one or both of servers 215 or 225 (FIG. 3)). This system may, for example, allow a user to author or import individual solutions, articles or documents that are then made available for searching by persons for whom that content may be useful. For example, a database of documents relating to a company, or enterprise, may be maintained by that company (e.g., at server 125 (FIG. 2) or one of servers 215 or 225 (FIG. 3)), and may be accessible to employees of the company. This system may also allow a user to edit articles or documents on the knowledge management system.

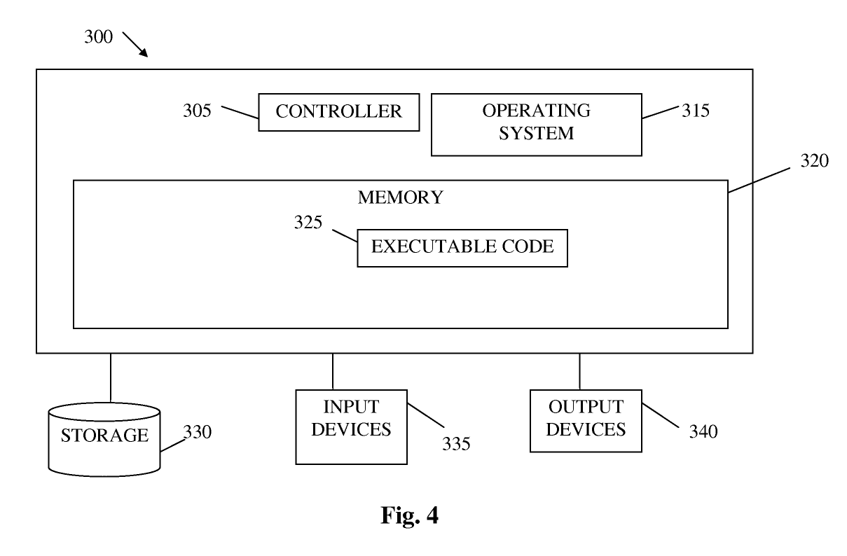

In certain embodiments, the system may include, for example, a repository (e.g., database(s), hard drive(s), flash drive(s), server(s) or other device(s) for storing data) of that knowledge such as, for example, storage 130 (FIG. 2), an interface such as, for example, a search portal interface, for searching and viewing the knowledge, and an interface such as, for example, a knowledge management interface, for adding and/or editing that knowledge. In certain embodiments, the search portal interface and/or knowledge management interface may be operated by, for example, web browser 112 located on user computing devices 111A-D (FIGS. 2 and 3), or may be operated by a browser on a server such as, for example, server 125 (FIG. 2) or one of servers 215 and server 225 (FIG. 3). In certain embodiments, a system may include one or more servers to, for example, operate a repository, including databases. In certain embodiments, the system may also include, for example, remote terminals (e.g., workstations or computer terminals) for operating a search portal interface and knowledge management interface and may be similar to, for example, exemplary computing device 300 (FIG. 4). In certain embodiments, the various units of the system may be connected by a wired or wireless network (e.g., network 140 (FIG. 2) or networks 241 and 242 (FIG. 3)) such as, for example, the Internet. Networks 241 and 242 may be the same network, or branches of the same network. The search portal and the knowledge management interfaces may also be at the server and accessed remotely via the wired or wireless network or Internet.

An authoring group, as referred to herein, may include users of the knowledge management system that may author documents or articles, create content-sensitive synonym sets, and create content-specific domains. In certain embodiments, an author or authoring group may be defined by which employment group, company department, or product team the author is associated with. Other parameters (e.g. geographic location, age group, security level, etc.) may be used to define an authoring group. In other embodiments, the author or authoring group may be determined by, for example, for which taxonomy, channel or audience the author or authoring group chooses to author a document.

In certain embodiments, an authoring group (e.g., members of the group) may be allowed to access only certain content-specific domains and may be restricted from accessing other content-specific domains. Access may be via computers or terminals 111, for example. For example, in a pharmaceutical company, a researcher belong to the group developing, for example, Product A may be able to access the domain specific to content regarding Product A only, and be restricted from accessing the domain specific to content regarding, for example, Product B. In certain embodiments, an authoring group may have access to all of the content-specific domains contained on the knowledge management system. In certain embodiments, if a user, author or authoring group has access to a content-specific domain, that user may also have authority to create content-sensitive synonym sets associated with the content-specific domain. In other embodiments, a user of the system may only have access to a content-specific domain in order to perform searches on the domain. For example, a university student may access to a domain specific to content regarding IT (information technology) services offered by the university, but may only have authority to search that domain.

In certain embodiments, an author or authoring group may author a document outside the knowledge management system and upload or add the document to the knowledge management system. In other embodiments, the author or authoring group may author or create a document on or using the knowledge management system. Certain embodiments may include a method and system for creating synonyms, synonym sets or for searching contexts associated with particular domains of content, based on, for example, an authoring group, an intended search audience, or a classification of content. Searching may be performed, for example, automatically, using a search process and a processor as described herein, and may be performed against or using the added synonyms or contexts.

For example, many companies or enterprises internally generate names for individual products such as, for example, an ERP solution name. However, instead of referring to the product by this internally generated name, a new proper name may be given to the product such as, for example, “Jane”. The company or enterprise may desire a search conducted on the term “Jane” to also list search results that refer to the internally generated name (e.g., the ERP product name), and vice-versa. In certain embodiments of the invention, a synonym may be created between or including these two names or terms. In certain embodiments, a user may create a synonym set including these two names or terms. The synonym set may include only these two names, or it may additionally include other terms or names that may refer to the same product.

In certain embodiments, the synonym set may be created within, or associated with, a content-specific domain such as, for example, the content-specific domain associated with the product “Jane”. In certain embodiments, content relevant to the product may be tagged (e.g., associated or affiliated) with the synonym set such that the content would be responsive to a search conducted on any term contained within the synonym set.

Embodiments of the invention may be used with content created for use in a public search engine, where synonyms in some subsets of content may be different from synonyms for other subsets of content. Terms could be added to tags within the content intended to enhance searching dependent on the general subject area of the articles being authored.

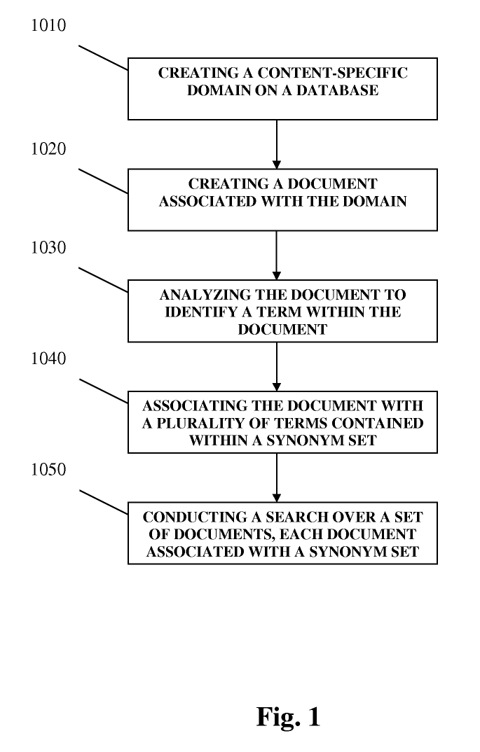

Reference is made to FIG. 1, which is a flow chart illustrating a method for the content-specific tagging of a document, including creating a content-specific domain on a database (operation 1010), creating or adding a document associated with the content-specific domain (operation 1020), analyzing the document or searching for terms in the document to identify a term within the document (operation 1030), the term being associated with, contained within, or affiliated with a content-sensitive synonym set assigned to, contained within, or associated with the content-specific domain. An embodiment may include associating the document with a plurality of terms contained within the content-sensitive synonym set based on the identified term in the document (operation 1040). A search may be conducted over the set of documents, and thus over the synonym terms associated with each document in the set of documents (operation 1050).

In certain embodiments the content-specific domain of operation 1010 may be created by an administrator, operator or user of the knowledge management system. In certain embodiments, the creator of the content-specific domain must have special permission or be privileged in order to create the content-specific domain. In other embodiments, any user may create the content-specific domain of operation 1010. In certain embodiments, a content-specific domain may be created only by an authoring group (e.g., employment group, company department, or product team) associated with the content contained in the content-specific domain. In some embodiments, it may be determined which synonym sets to apply to a document based on the domain associated with a document. However, methods of determining which synonym sets to be applied to a document other than using domains may be used.

In certain embodiments, a user (e.g., an author or authoring group) may not have access to all of the content-specific domains that have been created on the knowledge management system. For example, the domains that a user may have access to may be determined by the user's log-in information, employment identification number, or other parameter. For example, a user employed for the research and development of the product “Jane” may only have access to domains associated with (e.g., specific to) the research and development of the product “Jane”, and may not have access to domains associated with, for example, marketing the product “Jane”.

In certain embodiments, a user may create, edit or modify knowledge (e.g., a document or an article) associated with the content specific-domain (operation 1020). In certain embodiments, users with access to certain domains may only create, edit or modify documents for those domains they have access to. In other embodiments, a user, such as, for example, an administrator or high-ranking employee or official, may create, edit or modify documents associated with any domain contained on the knowledge management system. In certain embodiments, creating, editing or modifying a document as in, for example, operation 1020 of FIG. 1, may use a word processor or other document creation software module, for example executed locally to user device 111 or executed on server 125 (FIG. 2), server 215 (FIG. 3) or server 225 (FIG. 3).

In certain embodiments, each content-specific domain on the knowledge management system is associated with (e.g., contains) at least one content-sensitive synonym set. In some embodiments, each content-specific domain may be associated with a single content-sensitive synonym set. In other embodiments, each content-specific domain may be associated with a plurality (e.g., multiple) content-sensitive synonym sets. Each content-sensitive synonym set includes terms or phrases directed to the content contained on the content-specific domain it is associated with.

In certain embodiments, a user, author or authoring group may create, edit or modify the synonym sets associated with each domain such as in, for example, step 1040 of FIG. 1. In certain embodiments, a user may have flexibility in creating, editing or modifying the synonym sets in that the user may add new synonyms, delete old or irrelevant synonyms, or create an entirely new synonym set as the user gains additional knowledge about the content associated with the content-specific domain. In certain embodiments, if a user changes or modifies a synonym set by adding, deleting or editing a term or terms in the synonym set, the system may analyze the documents associated with the modified synonym set and update the terms associated with the documents according to the changes made to the synonym set.

As an example, a user or authoring group authoring solutions (e.g., documents or articles) in the networking group of a company may not want the terms “monitor” and “screen” to be synonymous, for the search purposes of that group, because they are not synonyms in the networking context. However, the information technology (IT) services group of the company may desire the terms “monitor” and “screen” to be synonymous in order to search for or create content specific to help debug issues with a computer display. In this example, the networking group and IT services group may have access to different content-specific domains associated with different content-sensitive synonym sets. In one domain (e.g., the networking domain) the terms “monitor” and “screen” may not be listed as synonyms in a synonym set, while in the other domain (e.g., the IT services domain) the terms may be listed as synonyms.

The search engine itself, such as the search portal interface, need not be aware of the domain-sensitive synonyms, since the document or article is already tagged with the appropriate synonyms per domain. Tagging (e.g., associating or affiliating) a document with a synonym set is explained in more detail below.

For example, operation 1030 of certain embodiments, includes analyzing a document to identify or search for a term, word or phrase within the document. In certain embodiments, the term identified within the document may be associated with, or contained within, a content-sensitive synonym set assigned (e.g., associated with) a content-specific domain. In certain embodiments, as content is being authored for a domain, the knowledge management system may analyze the content, identify a term in the content that is contained in a synonym set of the domain associated with the document, and add or associated all of the terms contained in the synonym set to the content (e.g., document). For example, if one term from a synonym set is in the actual documents, all terms from the synonym set may be associated with the document, or added to document metadata, to be used when searching for the document. In one embodiment for each term in the document which is contained within a synonym set (the synonym set including terms deemed to be synonyms), a process may add terms in the synonym set to metadata of the document. This process of adding terms of the synonym set to the content or metadata may be referred to herein as tagging the document. In certain embodiments, the analysis of content by the system may be performed automatically by the system as content is being created, modified or edited. In other embodiments, the analysis of content may be performed only when prompted by a user or author such as, for example, when a user or author clicks a ‘save’ button, or otherwise indicates that the documents should be saved to memory. (When discussed herein user input such as a “click” may be performed by a user manipulating a pointing device (e.g., device 335 of FIG. 4), such as a mouse or touchscreen, which can be used to move cursors or indicate icons, buttons, or other screen-displayed objects, and selecting those objects by, for example, clicking on a mouse button.)

In operation 1050, a search may be performed on or over the documents, for example documents added to a database. The search may be performed, for example, using a set of search terms (possibly with modifiers or connectors). The search may be performed, over a set of documents including documents having been augmented with synonym metadata, and thus the searching may include searching the synonym set terms in the metadata associated with the documents.

Terms added or associated to a document based on a synonym set analysis (e.g., terms or synonyms added to a document's metadata, or used to tag a document) may be used when a search is conducted over the group of documents including that document. When a search is performed over documents, the search terms may be matched for example in a conventional manner (using conventional search techniques) and/or to the terms added to a document based on synonym set analysis. For example, document A is associated with synonym set A, where synonym set A is (terms: Jane, XMDQ), and has had these two terms added to it as a result of document A including the term Jane, but not XMDQ. Document B is associated with synonym set B (terms: Jane, music) and has had these two terms added to it as a result of document B including the term Jane, but not music. When a search is conducted over the database including documents A and B with the search term music, document B will be returned as part of the search because it includes the term Jane, but not music, as for the domain of document B, Jane and music are synonyms. Searching for the term Jane may return both documents A and B.

Synonyms and context tagging rules may be defined per domain on the knowledge management system. Methods of determining which synonym sets to be applied to a document other than using or filtering based on domains may be used. Contexts may be determined using many of the standard ways contexts are determined (e.g., based on the document set being searched or analyzed, based on a user login or a group associated with a user login, or other methods). The rules of these applications can be customized at a per-set level and implemented to only analyzing the content of the set being tagged.

In certain embodiments, the terms added to content (e.g., to a document) from the synonym sets are added to a defined searchable field within the content (or, alternately, associated with the content), for example according to a pre-defined rule. The added data may be referred to as metadata or associated with metadata. The searchable field within the document may be invisible (e.g., embedded), and may not be seen or viewable by a user reviewing the content on the knowledge management system. The searchable field may be fully searchable by a search performed on the system. By performing a search via, for example, the search portal interface, the search may search on those tags as it would normally search. Accordingly, the differing tagging rules for the differing content sets translate to the searching and results in a transparent manner.

In certain embodiments, the knowledge management interface (e.g., via web browser 112 (FIG. 2)) may allow a user or author to add additional synonym sets. Adding a synonym set may include adding a list of words, phrases, or other terms (e.g., by accepting such a list from a user) for which a user may want to create a connection with, or equivalence to, other terms in a search. In certain embodiments, a term may also include or embody concepts that would not normally literally exist in an article but may act as a substitute for searching on a particular content area defined elsewhere in the system.

In certain embodiments, to create or add a content-specific domain, a user or author may operate a browser (e.g., web browser 112 (FIG. 2)), enter a URL of (or otherwise navigate to) the knowledge management interface, and possibly log in. The user may, for example, click on a link to ‘create a content domain’. For example, a user using a terminal 111 may, via a browser or other terminal software executed on terminal 111, communicate with a remote server such as server 215 or 225, which may provide software or data to appear on terminal 111 via browser, thus providing a user interface to a process executed on server 215 or 225 which performs methods described herein, such as adding a domain, tagging content, etc. The system may present criteria a user might use to define the name of the content-specific domain such as, for example, lists of titles, channels, solution author groups, or other criteria. The user or author may select which criteria apply to the domain the user is creating, and, for example, enter the name of the content domain. The user may click on a ‘save’ button or otherwise indicate save to save the domain, which may save this information to a database such as, for example, storage 130. In certain embodiments, the system may list in the knowledge management interface a list of existing domains with, for example, an ‘edit’ button next to each domain name. In certain embodiments, when the ‘edit’ button is clicked by a user it may present to the user or author selections for that domain and allow the user to update the selections and click ‘save’. Other methods or operations for creating a domain may be used.

In certain embodiments, to create or add a synonym, a user may for example click a link to ‘add/edit a synonym’ in a knowledge management interface. In certain embodiments, the system may list content-specific domains which have been created on the system. The user may select the domain this synonym will apply to. In certain embodiments, the system may present a list of content-specific synonym sets defined for that domain, with an option to, for example, edit any of the sets, and also an option to add a new synonym set and, for example, a button that says ‘add’. To add a new synonym set a user or author may enter (e.g., type, select using, for example, input devices 335 (FIG. 4)) a list of terms, separated by a comma or semicolon or some other separator, and may click ‘add’. The system may then save the new synonym set to a database such as, for example, database 130 (FIG. 2). Other methods or operations for creating a synonym may be used. In other embodiments, synonyms need not be associated with domains.

In certain embodiments, in order to have a synonym set applied to a document, a user or author may edit, create or add to a database or system an article or document. To edit document, a user may select an existing article in the database and click, or otherwise indicate, ‘edit’ and the system may retrieve that article from, for example, storage 130, for editing by the user. To add a document, a user may click ‘add’ and the system may present a new article template with empty fields such as, for example, text fields, to be filled in by the user. The user may click ‘save’ in the article. As used herein, the article template and fields may refer to data fields of a word processor or other document creation software module executed local to user device 111 or executed on server 125 or another server. In certain embodiments, the system may then evaluate the user, author, authoring groups, categories, etc. of (e.g., associated with) the article and determine what domain or domains the article should belong to. In other embodiments, the user may identify which domain or domains the article should belong to. For example, a user or author may choose which domain to create an article in. In certain embodiments, the system may obtain the list of content-sensitive synonym sets defined for (e.g., associated with) the domain or domains identified. The system may analyze (e.g., iterate or loop through) the data/text fields in the article and, if a term is found in a field that matches a term contained in the list of synonym sets, the other terms from that synonym set may be automatically added to an embedded (e.g. invisible) searchable field in the article, or added to article metadata, or otherwise associated with the article. The original data/text field of the article may remain unchanged for display purposes. Other methods or operations for applying a synonym may be used. For example, a user or other process may apply a synonym set to an article directly, without consideration of or use of a domain.

In certain embodiments, a synonym set does not have to be associated with a content-specific domain. For example, a synonym set may be attached to (e.g., associated or affiliated with) one or more contexts, or to one or more data structures that may define when the synonym set should be used by a search engine (e.g., the search portal interface) or other process to augment a search. For example, a synonym set may be attached (e.g., associated/affiliated with or linked) to use with a certain set of documents, a certain database, a certain group of users, or other type of parameter.

In certain embodiments, this synonym list may be different depending on the author group doing the authoring. This may be useful since often certain terms might apply to particular items for some sets of content but not others. For example, searching on ‘crm’ one might want to have ‘crmproducta’ as a synonym for content authored by one group, but use ‘crmproductb’ for another group.

In certain embodiments, synonym sets may also be pre-populated by certain pre-written lists of terms based on industry standards, or even suggested by a term clustering algorithm being run or executed on or against the set of content.

When a knowledge management user creates or edits a solution or document, it may be evaluated based on or against the synonym set list as it is being saved to the system. The searchable field or fields may be augmented (e.g., by a processor such as, for example, controller 305 as shown herein) with the alternate terms from the synonym lists.

In certain embodiment, when a search is executed via, for example, the search portal interface, it may optionally use a standard set of synonyms generated on the search-side of the search (e.g., automatically generated by a search engine when a search is executed as known in the art). These search-side synonyms may be used in addition to the content-side synonyms added to content on the knowledge management system using an embodiment of the present invention. In certain embodiments, using both search-side and content-side synonyms may add an extra level of granularity and power for searching the content on the knowledge management system.

In addition, potential performance benefits may be observed using a method of content-sensitive tagging of a document on the content creation side (e.g., when a user is authoring a document) such as described above, as opposed to on the search-side. For example, searching times scale linearly with the number of terms involved in the search. Traditional synonym usage adds terms on the search-side, which adds time for processing the search. Adding synonyms on the content-side as, for example, described herein, adds additional documents responsive to the search terms, and, therefore, adds little or no additional time to the search. In some embodiments, little or no extra processing is required to take advantage of this performance benefit; it naturally occurs because of the way the work is done at time of document creation rather than at the time of search.

Certain embodiments of the present invention may include a knowledge management system including a memory to store a plurality of content-specific domains, each domain containing a plurality of documents, and being associated with a plurality of content-sensitive synonym sets, and a computer processor to analyze a document contained on at least one of the content-specific to identify a term, the term being associated with at least one of the plurality of content-sensitive synonym sets associated with the domain and associating the document with a plurality of terms contained within the at least one content-sensitive synonym set based on the term identified in the document.

Reference is now made to FIGS. 2 and 3, which are block diagrams of systems 100 and 200 according to embodiments of the invention. Systems 100 and 200 may include one or more network(s) 140, 241 and 242 (e.g. the Internet), and one or more user computing device(s) or terminals 111A, 111B, 111C and 111D connected to network(s) 140, 241 and/or 242. Each of devices 111A, 111B, 111C and 111D may include a world wide web (web) browser or other remote terminal software module 112 (shown only within device 111A in FIG. 2). Systems 100 and 200 may include for example one or more servers 115, 215 and 225 (e.g., providing documents across the Internet). Computing device(s) 111A-D, and servers 115, 215 and 225, may all communicate by and send signals to each other via network(s) 140, 241 and/or 242. Network(s) 140, 241 and/or 242 may be or include a private or public internet protocol (IP) network, the Internet, other networks, or a combination of networks.

In one embodiment, server 215 provides functionality described herein such as creating synonyms and applying the synonyms to documents, to a number of users, for example to various enterprises (e.g., Company A and Company B). In such a case, typically, each enterprise accesses a different set of documents, the documents being hosted by server 215 or a server local to the enterprise. In another embodiment, server 225 provides some functionality or software to server 215 and a number of other similar servers, which in turn provide services to a number of users, for example to various enterprises (e.g., Company A and Company B). In other embodiments, a server 215 may be within an organization (e.g., within Company A), providing functionality to users. Other arrangements, for example not including enterprise-organized services (e.g., not including servers providing services to specific companies) may be used.

User computing devices 111A-D may be client computing device(s), e.g., a computing device operated by an end-user viewing documents, editing documents, viewing web content, etc. Computing devices 111A-D may include, for example, personal computers, terminals, workstations, Personal Digital Assistants (PDAs), cellular phones, etc.

Server(s) 115, 215 and 225 may be or may include one or more suitable server computers as known in the art. Storage 130 (shown only in FIG. 2) may include, for example, a hard disk drive, a floppy disk drive, a Compact Disk (CD) drive, a CD-Recordable (CD-R) drive, or other suitable removable and/or fixed storage unit.

Server(s) 115, 215 and 225, and user computing devices 111A-D may include processor(s) and memory unit(s), and other units, as shown for example in FIG. 4.

Server(s) 115, 215 and 225 may be a web server as known in the art and may, accordingly, support web sites, provide web pages or other content objects, handle hyper text transfer protocol (HTTP) and/or hyper text markup language (HTML), manipulate cookies or perform any operations related to a web server or application as known in the art. Web browser or terminal 112 (shown only in FIG. 2) may be any web browser, e.g., a commercial web browser or any module or application capable of receiving content objects and providing or presenting content to a user. Web browser 112 may receive and display, present or provide content received from server(s) 115, 215 or 225. Web browser or terminal 112 may be a remote terminal program.

While different functions are described in the examples given as being performed by entities 111, 115, 215, 125, and 225, in other embodiments, functionality described herein may be performed by different units, and functionality may be combined. For example, a server (e.g., 215 or 225) may store documents, be used to create domains or synonyms, perform searches, and be directly accessed by a user. Searches, clustering, and other functionality may be provided by a processor at a user device 111A.

A server(s) (e.g., 215 or 225) in conjunction with a user device 111 may provide the functionality of a method described herein. A server (e.g., 215 or 225) may maintain a repository (e.g. database), and sets of domains, rules and/or synonyms (e.g., lists of words that are similar within certain domains). A server (e.g., 215 or 225) may operate a search engine or search process (e.g., accessed via a user terminal) to search over a database, or over documents maintained on the Internet. For example, a user may access a user device 111 to operate a browser 112, which accesses server (e.g., 215 or 225) to search for documents, upload documents, etc. A user may access a user device 111 to create or edit a document (e.g., using a word processor or other document creation software module executed local to user device 111 or executed on server(s) 215 or 225).

Reference is made to FIG. 4, showing high level block diagram of an exemplary computing device 300 according to embodiments of the present invention. Any of devices 111A-111D, web server(s) 115 or 215, and server(s) 215 or 225 may be or include a structure similar to the example of computing device 300 shown in FIG. 4. Computing device 300 may include a controller 305 that may be, for example, a central processing unit processor (CPU), a chip or any suitable computing or computational device, an operating system 315, a memory 320, a storage 330, an input device 335 and an output device 340.

Memory 320 may be or may include, for example, one or more of a Random Access Memory (RAM), a read only memory (ROM), a Dynamic RAM (DRAM), a Synchronous DRAM (SD-RAM), a double data rate (DDR) memory chip, a Flash memory, volatile or non-volatile memory, a cache, a buffer, or other suitable memory units or storage units.

Executable code 325 may be executed by controller 305 possibly under control of operating system 315. Executable code 325 may include, for example, browser 112, module 113, or software or code effecting various embodiments described herein. Storage 330 may be or may include, for example, a hard disk drive, a floppy disk drive, a Compact Disk (CD) drive, or other suitable removable and/or fixed storage unit.

Input devices 335 may be or may include a mouse, a keyboard, a touch screen or pad or any suitable input device. Output devices 340 may include one or more monitors, displays, speakers and/or any other suitable output devices. According to embodiments of the invention, servers 125, 225, 115 and 215 and user devices 111A-D may include all or some of the components comprised in computing device 300 as shown and described herein.

Embodiments of the invention may include an article such as a computer or processor readable medium, a machine-readable medium, or a non-transitory computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 320, computer-executable instructions such as executable code 325 and a controller such as controller 305 may be used to carry out methods described herein.

Various embodiments are described herein, with various features. In some embodiments, certain features may be omitted, or features from one embodiment may be used with another embodiment. Modifications of embodiments of the present invention will occur to persons skilled in the art. All such modifications are within the scope and spirit of the present invention as defined by the appended claims.

What is claimed is:

1. A method for the content-sensitive tagging of a document, the method comprising:
analyzing a document associated with a content-specific domain to identify a term within the document, the term being associated with a content-sensitive synonym set assigned to the content-specific domain; and
associating the document with a plurality of terms contained within the content-sensitive synonym set based on the identified term in the document.

2. The method according to claim 1, comprising searching a set of documents including the document by searching over terms contained within the content-sensitive synonym set associated with the document.

3. The method according to claim 2, comprising searching against a plurality of synonyms generated by a search engine.

4. The method according to claim 1, wherein the document is analyzed as the document is being created.

5. The method according to claim 1, wherein the document is analyzed after the document has been created.

6. The method according to claim 1, wherein associating the document with a plurality of terms comprises adding the terms to the document.

7. The method according to claim 6, wherein adding the terms comprises adding the terms to a searchable field in the document.

8. The method according to claim 7, wherein the searchable field is invisible.

9. A knowledge management system, the system comprising:
a memory to store a plurality of content-specific domains, each domain containing a plurality of documents, each domain being associated with a plurality of content-sensitive synonym sets; and
a processor to:
analyze a document contained on at least one of the content-specific domains to identify a term, the term being associated with at least one of the plurality of content-sensitive synonym sets associated with the domain; and
associate the document with a plurality of terms contained within the at least one content-sensitive synonym set based on the term identified in the document.

10. The knowledge management system according to claim 9, wherein the processor searches a set of documents including the document by searching over terms contained within the content-sensitive synonym set associated with the document.

11. The knowledge management system according to claim 10, comprising searching against a plurality of synonyms generated by the search engine.

12. The knowledge management system according to claim 9, wherein the document is analyzed as the document is being created.

13. The knowledge management system according to claim 9, wherein the document is analyzed after the document has been created.

14. The knowledge management system according to claim 9, wherein associating the document with a plurality of terms comprises adding the terms to the document.

15. A method for adding search terms to a document, the method comprising:
searching for terms in the document;
for each term in the document which is contained within a synonym set of terms deemed to be a synonym, adding terms in the synonym set to metadata of the document.

16. The method of claim 15, comprising searching, using a set of search terms, over a set of documents including the document, the searching including searching the synonym set terms in the metadata.

17. The method of claim 15, wherein the metadata is a searchable field associated with the document.

18. The method of claim 15, wherein the metadata is not viewable by a user reviewing the document.

19. The method of claim 15, wherein the document is contained within a document database, and wherein for different documents within the document database, a different synonym set of terms used for term addition.

20. The method of claim 15, comprising adding terms of a synonym set to the metadata of a document only if the document and synonym set are in the same content-specific domain.
